(19) United States
(12) Patent Application Publication
(10) Pub. No.: US 2024/0255178 A1
(43) Pub. Date: Aug. 1, 2024

(54) AIR PASSAGE TYPE SILENCER

(71) Applicant: FUJIFILM Corporation, Tokyo (JP)

(72) Inventors: Yuichiro ITAI, Ashigarakami-gun (JP); Yoshihiro SUGAWARA, Ashigarakami-gun (JP); Shogo YAMAZOE, Ashigarakami-gun (JP); Shinya HAKUTA, Ashigarakami-gun (JP); Tomohiro TAKAHASHI, Ashigarakami-gun (JP)

(73) Assignee: FUJIFILM Corporation, Tokyo (JP)

(21) Appl. No.: 18/632,651

(22) Filed: Apr. 11, 2024

Related U.S. Application Data
(63) Continuation of application No. PCT/JP2022/035066, filed on Sep. 21, 2022.

(30) Foreign Application Priority Data
Oct. 26, 2021 (JP) 2021-174496
Jul. 5, 2022 (JP) 2022-108149

(51) Int. Cl. F24F 13/02

(52) U.S. Cl. CPC F24F 13/0263

(57) ABSTRACT

Provided is an air passage type silencer that can drain water from the inside of an expansion portion and that can suppress generation of a wind noise. An air passage type silencer includes an inlet-side ventilation pipe, an expansion portion that communicates with the inlet-side ventilation pipe and of which a cross-sectional area is larger than a cross-sectional area of the inlet-side ventilation pipe, an outlet-side ventilation pipe that communicates with the expansion portion and of which a cross-sectional area is smaller than a cross-sectional area of the expansion portion, an opening portion structure that is provided at at least one of a connection portion between the expansion portion and the inlet-side ventilation pipe or a connection portion between the expansion portion and the outlet-side ventilation pipe and of which a cross-sectional area gradually increases from the connection portion toward an inside of the expansion portion, and a sound absorbing material that is disposed at least between an inner peripheral surface of the expansion portion and a distal end of the opening portion structure. The opening portion structure includes a cutout portion formed from the distal end to a root side at a portion of a peripheral surface, and a width of the cutout portion gradually increases from the root side toward the distal end.

### CROSS-REFERENCE TO RELATED APPLICATIONS

This application is a Continuation of PCT International Application No. PCT/JP2022/035066 filed on Sep. 21, 2022, which claims priority under 35 U.S.C. § 119(a) to Japanese Patent Application No. 2021-174496 filed on Oct. 26, 2021 and Japanese Patent Application No. 2022-108149 filed on Jul. 5, 2022. The above applications are hereby expressly incorporated by reference, in their entirety, into the present application.

### BACKGROUND OF THE INVENTION

### 1. Field of the Invention

The present invention relates to an air passage type silencer.

### 2. Description of the Related Art

As a silencer that attenuates a noise from a gas supply source or the like at a ventilation path intermediate position of a ventilation pipe through which a gas is transported, an air passage type silencer that is installed at the ventilation path intermediate position and that includes an expansion portion of which the cross-sectional area is larger than that of the ventilation pipe is known.

Regarding the air passage type silencer including the expansion portion, it is known that turbulence of wind flowing into the expansion portion is suppressed and a sound attenuation effect is enhanced in a case where a horn-shaped member, of which the cross-sectional area gradually decreases toward the inside of the expansion portion, is disposed at an entrance and exit port of the expansion portion.

For example, described in JP1986-184808Y (JP-S61-184808Y) is an expansive type silencer obtained by inserting an inlet pipe and a tail pipe (an outlet pipe) into an expansion portion, the inlet pipe and the tail pipe inserted into the expansion portion are formed to be tapered (in a horn-like shape) in the expansion portion, bell mouths are formed at opening portions of the inlet pipe and the tail pipe, and the bell mouths are provided to face each other.

Meanwhile, in a case where an air passage type silencer is to be installed in an air conditioner, a humidifier, or the like, it is necessary that high-humidity air passes through the air passage type silencer. In the case of the air passage type silencer through which high-humidity air passes, the probability of generation of mold or the like is high and thus improvement in moisture resistance is required. In addition, in a case where the air passage type silencer is cooled by low-temperature outside air and condensation occurs in an air passage path, water may be accumulated in an expansion portion and the water needs to be discharged to the outside. In addition, although it is conceivable to dispose a porous sound absorbing material in the expansion portion for improvement in sound attenuation performance, it is necessary to prevent the porous sound absorbing material from coming into contact with high-humidity wind and absorbing moisture.

Described in JP1984-184315U (JP-S59-184315U) is a technique in which a discharge gas lead-out pipe is brought into contact with an interior wall lower surface of a hollow body (an expansion portion) in an expansion type silencer and a large number of small holes or micropores are formed in a portion of the discharge gas lead-out pipe that is in contact with the interior wall lower surface of the hollow body so that water in the hollow body (the expansion portion) is discharged.

### SUMMARY OF THE INVENTION

However, according to the study of the present inventors, it has been found that air flowing through a horn-shaped member disposed in an expansion portion is made turbulent by a through-hole and a wind noise is generated in a case where the through-hole is formed in the horn-shaped member for the purpose of performing drainage.

An object of the present invention is to provide an air passage type silencer that can drain water from the inside of an expansion portion and that can suppress generation of a wind noise while solving the above-described problem of the related art.

Therefore, an object achieved by not providing a through-hole for drainage in the present invention is to prevent generation of a wind noise which is caused in a case where the flow of air is made turbulent due to the through-hole.

The same object needs to be achieved for any air passage type silencer even in the case of an air passage type silencer that is not an expansion type air passage type silencer. That is, even in the case of an air passage type silencer that does not include a horn-shaped member, in a case where a through-hole for drainage is provided, a problem in which air flowing through the air passage type silencer is made turbulent by the through-hole and a wind noise is generated occurs.

An additional object achieved in a case where a drainage mechanism is further provided in the present invention is that water can be drained from the inside of the air passage type silencer to the outside in a case where no through-hole is provided in the air passage type silencer.

Another additional object of the present invention is to make it possible to further improve the drainability in a case where a material of which the water absorption rate is low or that does not absorb water is used as a base material of a sound absorbing material in the air passage type silencer. As a result, moisture remaining in the air passage type silencer can be reduced, and generation of mold and the like can be reduced.

In order to solve the above-described problem, the present invention has the following configurations.
[1] An air passage type silencer including:
an opening portion structure on each of an inlet side and an outlet side,
in which the opening portion structure includes a drainage mechanism provided at a portion of an edge portion of the opening portion structure.
[2] An air passage type silencer including:
an inlet-side ventilation pipe;
an expansion portion that communicates with the inlet-side ventilation pipe and of which a cross-sectional area is larger than the cross-sectional area of the inlet-side ventilation pipe;
an outlet-side ventilation pipe that communicates with the expansion portion and of which a cross-sectional area is smaller than a cross-sectional area of the expansion portion;
an opening portion structure that is provided at at least one of a connection portion between the expansion portion and the inlet-side ventilation pipe or a connection portion between the expansion portion and the outlet-side ventilation pipe and of which a cross-sectional area gradually increases from the connection portion toward an inside of the expansion portion; and
a sound absorbing material that is disposed at least between an inner peripheral surface of the expansion portion and a distal end of the opening portion structure,
in which the opening portion structure includes a cutout portion formed from the distal end to a root side at a portion of a peripheral surface, and
a width of the cutout portion gradually increases from the root side toward the distal end.
[3] The air passage type silencer described in [2],
in which the opening portion structure is provided at each of the connection portion between the expansion portion and the inlet-side ventilation pipe and the connection portion between the expansion portion and the outlet-side ventilation pipe.
[4] The air passage type silencer described in [2] or [3],
in which the sound absorbing material is a porous sound absorbing material.
[5] The air passage type silencer described in [4], in which the porous sound absorbing material includes a base material that consists of resin, and a surface layer consisting of a resin nonwoven fabric on a surface of the base material,
the porous sound absorbing material is disposed such that a surface layer side faces an opening portion structure side.
[6] The air passage type silencer described in [5],
in which a water absorption rate of resin for the base material of the porous sound absorbing material is 0.5% or less.
[7] The air passage type silencer described in any one of [4] to [6],
in which a central axis of the inlet-side ventilation pipe and a central axis of the outlet-side ventilation pipe coincide with each other, and
the porous sound absorbing material is disposed along the inner peripheral surface of the expansion portion over an entire region in a direction along the central axes.
[8] The air passage type silencer described in any one of [4] to [7],
in which the porous sound absorbing material is in contact with a maximum diameter portion of the opening portion structure.
[9] The air passage type silencer described in any one of [2] to [8],
in which a central axis of the inlet-side ventilation pipe and a central axis of the outlet-side ventilation pipe are disposed to be parallel to a vertical direction, and
the opening portion structure including the cutout portion is disposed at a side surface of the expansion portion that is on a lower side in the vertical direction.
[10] The air passage type silencer described in any one of [1] to [9], in which the opening portion structure does not include a through-hole.

According to the present invention, it is possible to provide an air passage type silencer that can drain water from the inside of an expansion portion and that can suppress generation of a wind noise.

In addition, according to the present invention, even for an air passage type silencer other than an expansion type air passage type silencer, it is possible to provide an air passage type silencer that can prevent generation of a wind noise which is caused in a case where the flow of air is made turbulent due to a through-hole since no through-hole is not provided for drainage.

In addition, according to the present invention, it is possible to provide an air passage type silencer in which water can be drained from the inside of the air passage type silencer to the outside without a through-hole which is likely to cause a wind noise.

In addition, according to a preferred embodiment of the present invention, a material of which the water absorption rate is low or that does not absorb water is used as a base material of a sound absorbing material disposed in an air passage type silencer and thus it possible to further improve the drainability. As a result, moisture remaining in the air passage type silencer can be reduced, and generation of mold and the like can be reduced.

### BRIEF DESCRIPTION OF THE DRAWINGS

FIG. 1 is a cross-sectional view conceptually showing an example of an air passage type silencer according to an aspect of the present invention.

FIG. 2 is a perspective view schematically showing an example of an opening portion structure that the air passage type silencer shown in FIG. 1 includes.

FIG. 3 is a front view of the opening portion structure shown in FIG. 2.

FIG. 4 is a side view showing the opening portion structure shown in FIG. 2.

FIG. 5 is a perspective view schematically showing another example of the opening portion structure.

FIG. 6 is a front view of the opening portion structure shown in FIG. 5.

FIG. 7 is a side view of the opening portion structure shown in FIG. 5.

FIG. 8 is a perspective view conceptually showing an example of a porous sound absorbing material that the air passage type silencer shown in FIG. 1 includes.

FIG. 9 is a perspective view schematically showing an opening portion structure that an air passage type silencer in a comparative example includes.

FIG. 10 is a perspective view schematically showing a porous sound absorbing material that an air passage type silencer in a comparative example includes.

FIG. 11 is a view for description about a wind speed measuring method.

FIG. 12 is a view for description about a sound attenuation amount measuring method.

FIG. 13 is a perspective view schematically showing an opening portion structure including another example of a drainage mechanism.

FIG. 14 is a perspective view schematically showing an opening portion structure including another example of a drainage mechanism.

FIG. 15 is a perspective view schematically showing an opening portion structure including another example of a drainage mechanism.

### DESCRIPTION OF THE PREFERRED EMBODIMENTS

Hereinafter, the present invention will be specifically described.

Although configuration requirements to be described below may be described based on a representative embodiment of the present invention, the present invention is not limited to such an embodiment.

Note that, in the present specification, a numerical range represented using “to” means a range including numerical values described before and after the preposition “to” as a lower limit value and an upper limit value.

In addition, in the present specification, “perpendicular” and “parallel” include a range of errors accepted in the technical field to which the present invention belongs. For example, “being perpendicular” or “being parallel” means being in a range of less than ±10° or the like with respect to being strictly perpendicular in the strict sense or being parallel in the strict sense and the error with respect to being strictly perpendicular in the strict sense or being parallel in the strict sense is preferably 5° or less, and more preferably 3° or less.

In the present specification, the meanings of “the same”, and “identical” may include a range of errors generally accepted in the technical field.

### [Air Passage Type Silencer]

An air passage type silencer according to an embodiment of the present invention is an air passage type silencer including:
an opening portion structure on each of an inlet side and an outlet side,
in which the opening portion structure includes a drainage mechanism provided at a portion of an edge portion of the opening portion structure.

In addition, the air passage type silencer according to the embodiment of the present invention is an air passage type silencer including:
an inlet-side ventilation pipe;
an expansion portion that communicates with the inlet-side ventilation pipe and of which a cross-sectional area is larger than a cross-sectional area of the inlet-side ventilation pipe;
an outlet-side ventilation pipe that communicates with the expansion portion and of which a cross-sectional area is smaller than the cross-sectional area of the expansion portion;
an opening portion structure that is provided at at least one of a connection portion between the expansion portion and the inlet-side ventilation pipe or a connection portion between the expansion portion and the outlet-side ventilation pipe and of which a cross-sectional area gradually increases from the connection portion toward an inside of the expansion portion; and
a sound absorbing material that is disposed at least between an inner peripheral surface of the expansion portion and a distal end of the opening portion structure,
in which the opening portion structure includes a cutout portion formed from the distal end to a root side at a portion of a peripheral surface, and
a width of the cutout portion gradually increases from the root side toward the distal end.

In addition, as a preferable aspect, the air passage type silencer according to the embodiment of the present invention has a configuration in which the sound absorbing material is a porous sound absorbing material. Furthermore, as a preferable aspect, the air passage type silencer according to the embodiment of the present invention has a configuration in which the porous sound absorbing material includes a base material that consists of resin and a surface layer that is on a surface of the base material and that consists of a resin nonwoven fabric, and the porous sound absorbing material is disposed such that a surface layer side faces an opening portion structure side.

The configuration of the air passage type silencer according to the embodiment of the present invention will be described with reference to the drawings.

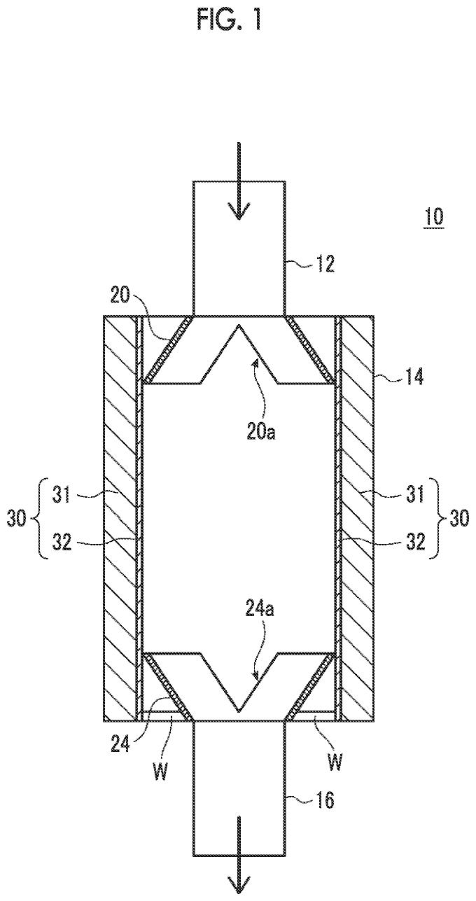

FIG. 1 is a schematic cross-sectional view showing an example of an embodiment of the air passage type silencer according to the embodiment of the present invention.

As shown in FIG. 1, an air passage type silencer 10 includes a tubular inlet-side ventilation pipe 12, an expansion portion 14 connected to one opening edge surface of the inlet-side ventilation pipe 12, a tubular outlet-side ventilation pipe 16 that is connected to an edge surface of the expansion portion 14 on a side opposite to the inlet-side ventilation pipe 12, a first opening portion structure 20, a second opening portion structure 24, and a porous sound absorbing material 30.

In an example shown in FIG. 1, as a preferable aspect, the outlet-side ventilation pipe 16 is disposed below the expansion portion 14 in a vertical direction and the inlet-side ventilation pipe 12 is disposed above the expansion portion 14 in the vertical direction. That is, in the example shown in FIG. 1, the up-down direction is the vertical direction. In addition, in the example shown in the drawing, air flows from an upper side to a lower side in the drawing through the air passage type silencer. That is, a direction in which the air flows in the air passage type silencer coincides with the vertical direction.

The inlet-side ventilation pipe 12 is a tubular member through which a gas that flows into the inlet-side ventilation pipe 12 through one opening edge surface is transported to the expansion portion 14 connected to the other opening edge surface.

The outlet-side ventilation pipe 16 is a tubular member through which a gas that flows into the outlet-side ventilation pipe 16 through one opening edge surface connected to the expansion portion 14 is transported to the other opening edge surface.

The cross-sectional shapes of the inlet-side ventilation pipe 12 and the outlet-side ventilation pipe 16 (hereinafter, collectively referred to as ventilation pipes) may be various shapes such as a circular shape, a rectangular shape, and a triangular shape. In addition, the cross-sectional shape of a ventilation pipe may not be constant in an axial direction along a central axis of the ventilation pipe. For example, the diameter of the ventilation pipe may change in the axial direction.

The inlet-side ventilation pipe 12 and the outlet-side ventilation pipe 16 may have the same cross-sectional shape and cross-sectional area, or may have different shapes and/or cross-sectional areas. In addition, in an example shown in FIG. 1, the inlet-side ventilation pipe 12 and the outlet-side ventilation pipe 16 are disposed such that central axes thereof coincide with each other. However, the present invention is not limited thereto and the central axis of the inlet-side ventilation pipe 12 and the central axis of the outlet-side ventilation pipe 16 may be offset from each other.

The sizes (the cross-sectional areas or the like) of the inlet-side ventilation pipe 12 and the outlet-side ventilation pipe 16 may be set as appropriate in accordance with the size of a device in which the air passage type silencer is used, the required air passage performance, and the like.

As described above, the inlet-side ventilation pipe 12 and the outlet-side ventilation pipe 16 are disposed such that the air flows to the lower side in the vertical direction. That is, the central axes of the inlet-side ventilation pipe 12 and the outlet-side ventilation pipe 16 are disposed to be parallel to the vertical direction.

The expansion portion 14 is disposed between the inlet-side ventilation pipe 12 and the outlet-side ventilation pipe 16 and transports, to the outlet-side ventilation pipe 16, a gas that flows into the expansion portion 14 from the inlet-side ventilation pipe 12.

The cross-sectional area of the expansion portion 14 that is perpendicular to a flow path direction is larger than the cross-sectional area of the inlet-side ventilation pipe 12 and is larger than the cross-sectional area of the outlet-side ventilation pipe 16. That is, for example, in a case where the cross-sectional shapes of the inlet-side ventilation pipe 12, the outlet-side ventilation pipe 16, and the expansion portion 14 are circular, the diameter of the cross-section of the expansion portion 14 is larger than the diameters of the inlet-side ventilation pipe 12 and the outlet-side ventilation pipe 16.

The cross-sectional shape of the expansion portion 14 may be various shapes such as a circular shape, a rectangular shape, and a triangular shape. In addition, the cross-sectional shape of the expansion portion 14 may not be constant in an axial direction along a central axis of the expansion portion 14. For example, the diameter of the expansion portion 14 may change in the axial direction.

The size (the length, the cross-sectional area, or the like) of the expansion portion 14 may be set as appropriate in accordance with the size of a device in which the air passage type silencer is used, the required sound attenuation performance, and the like.

The first opening portion structure 20 is disposed at the position of connection between the expansion portion 14 and the inlet-side ventilation pipe 12 and the second opening portion structure 24 is disposed at the position of connection between the expansion portion 14 and the outlet-side ventilation pipe 16. In addition, the porous sound absorbing material 30 is disposed along an inner peripheral surface of the expansion portion 14.

The porous sound absorbing material 30 is disposed at least between the inner peripheral surface of the expansion portion 14 and distal ends of the opening portion structures to absorb and attenuate a sound. In the example shown in the drawing, the porous sound absorbing material is disposed along the inner peripheral surface of the expansion portion 14 over the entire region in a central axis direction of the ventilation pipes. That is, the length of the porous sound absorbing material 30 in the flow path direction approximately coincides with the length of the expansion portion 14 in the flow path direction. In addition, it is preferable that the porous sound absorbing material 30 has such a thickness in a direction perpendicular to the flow path direction that the porous sound absorbing material 30 does not overlap with the ventilation pipes as seen in the flow path direction. In the example shown in the drawing, the porous sound absorbing material 30 has such a thickness that the porous sound absorbing material 30 comes into contact with a maximum diameter portion of the first opening portion structure 20 and a maximum diameter portion of the second opening portion structure 24.

For example, in a case where the expansion portion 14 has a cylindrical shape, the porous sound absorbing material 30 may have a cylindrical shape matching the shape of a peripheral surface of the expansion portion 14. In addition, in a case where the expansion portion 14 has a quadrangular tube-like shape, the porous sound absorbing material 30 may have a quadrangular tube-like shape matching the shape of the peripheral surface of the expansion portion 14.

As shown in FIG. 8, the porous sound absorbing material 30 includes a base material 31 consisting of resin and a surface layer 32 consisting of a resin nonwoven fabric, the surface layer 32 being on a surface of the base material 31. As shown in FIG. 1, the porous sound absorbing material 30 is disposed such that the surface layer 32 side faces a side on which the first opening portion structure 20 and the second opening portion structure 24 are disposed.

The base material 31 of the porous sound absorbing material 30 is not particularly limited, and a porous sound absorbing material that consists of resin and that is publicly known in the related art can be used as appropriate. For example, various known porous sound absorbing materials such as a foaming body consisting of resin such as polyester, synthetic rubber sponge (EPDM-based), and the like, a foaming material (foaming urethane foam (for example, CALMFLEX F manufactured by INOAC CORPORATION, urethane foam manufactured by Hikari Co., Ltd., and the like), flexible urethane foam, phenol foam, melamine foam, a polyamide foam, and the like), a nonwoven fabric, and the like can be used.

In addition, the surface layer 32 of the porous sound absorbing material 30 is not particularly limited, and a nonwoven fabric that consists of resin and that is publicly known in the related art can be used as appropriate. For example, various known nonwoven fabrics such as a nonwoven fabric sound absorbing material (a microfiber nonwoven fabric (for example, Thinsulate manufactured by 3M Company and the like), a polyester nonwoven fabric (for example, White Kyuon manufactured by TOKYO Bouon), a plastic nonwoven fabric such as an acrylic fiber nonwoven fabric, and a natural fiber nonwoven fabric such as wool and felt) can be used.

Examples of the porous sound absorbing material including the base material and the surface layer include QonPET manufactured by Bridgestone KBG Co., Ltd. (base material: polyester nonwoven fabric, surface layer: polyester nonwoven fabric), CALMFLEX F manufactured by INOAC CORPORATION (base material: urethane, surface layer: polyester nonwoven fabric), and a sound-absorbing board manufactured by IMAO CORPORATION (base material: urethane, surface layer: polyvinylchloride (PVC)). In a case where both the base material and the surface layer consist of a nonwoven fabric, a layer having a high density is regarded as the surface layer.

From the viewpoint of drainability, the water absorption rate of resin for the base material 31 of the porous sound absorbing material 30 is preferably 0.5% or less, and more preferably 0.3% or less. Examples of such resin include polyester resin and melamine resin.

The first opening portion structure 20 is a tapered tubular member that is disposed to be in contact with a connection portion with respect to the inlet-side ventilation pipe 12 in the expansion portion 14 and of which the opening area gradually increases from the inlet-side ventilation pipe 12 toward the outlet-side ventilation pipe 16.

In the example shown in the drawing, the shape and the area of an opening of the first opening portion structure 20 that is on the inlet-side ventilation pipe 12 side approximately coincide with the cross-sectional shape and the cross-sectional area of the inlet-side ventilation pipe 12. In addition, an edge surface (hereinafter, may be referred to as a distal end) of the first opening portion structure 20 that is on the outlet-side ventilation pipe 16 side does not come into contact with the peripheral surface of the expansion portion 14. In the example shown in the drawing, the edge surface of the first opening portion structure 20 that is on the outlet-side ventilation pipe 16 side is in contact with the porous sound absorbing material 30 disposed along an inner side of the peripheral surface of the expansion portion 14.

The second opening portion structure 24 is a tapered tubular member that is disposed to be in contact with a connection portion with respect to the outlet-side ventilation pipe 16 in the expansion portion 14 and of which the opening area gradually decreases from the inlet-side ventilation pipe 12 toward the outlet-side ventilation pipe 16.

In the example shown in the drawing, the shape and the area of an opening of the second opening portion structure 24 that is on the outlet-side ventilation pipe 16 side approximately coincide with the cross-sectional shape and the cross-sectional area of the outlet-side ventilation pipe 16. In addition, an edge surface (a distal end) of the second opening portion structure 24 that is on the inlet-side ventilation pipe 12 side does not come into contact with the peripheral surface of the expansion portion 14. In the example shown in the drawing, the edge surface of the second opening portion structure 24 that is on the inlet-side ventilation pipe 12 side is in contact with the porous sound absorbing material 30 disposed along the inner side of the peripheral surface of the expansion portion 14.

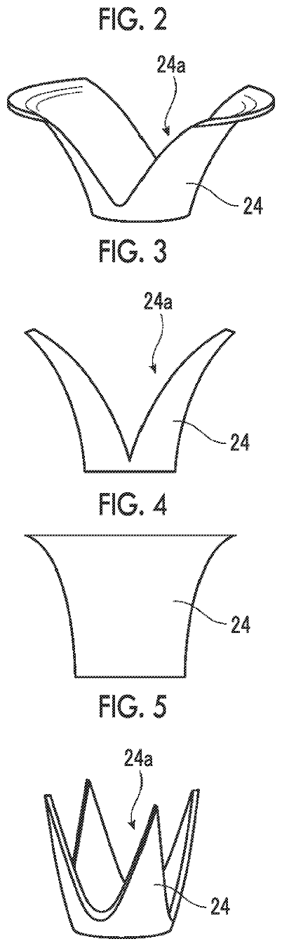

Here, each of the first opening portion structure 20 and the second opening portion structure 24 includes cutout portions (20a, 24a) formed from the distal end to a root side at a portion of a peripheral surface. FIG. 2 shows a perspective view of the second opening portion structure 24 that the air passage type silencer 10 shown in FIG. 1 includes. FIG. 3 shows a front view of the second opening portion structure 24 shown in FIG. 2, and FIG. 4 shows a side view of the second opening portion structure 24. Note that although the description will be made while using the second opening portion structure 24 shown in FIGS. 2 to 4 as a representative sample, the first opening portion structure 20 has the same configuration as the second opening portion structure 24.

The cutout portion corresponds to a drainage mechanism according to the embodiment of the present invention.

As shown in FIGS. 2 to 4, the second opening portion structure 24 is a trumpet-shaped tubular member of which the cross-sectional area gradually increases from the root side toward the distal end side and the second opening portion structure 24 includes cutout portions 24a that are formed from the distal end to the root side at a portion of a peripheral surface of the second opening portion structure 24. That is, the cutout portions 24a are open on the distal end side. In addition, as shown in the drawings, the width of each cutout portion 24a gradually increases from the root side toward the distal end side. In addition, in an example shown in the drawings, the second opening portion structure 24 includes two cutout portions 24a disposed at positions facing each other.

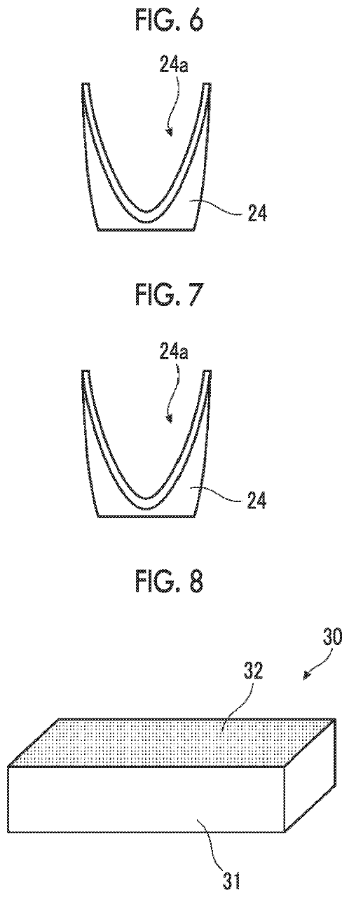

Note that although the second opening portion structure 24 in the example shown in FIGS. 2 to 4 has a configuration in which two cutout portions 24a are provided, the present invention is not limited thereto and the opening portion structure may have a configuration in which one cutout portion is provided or may have a configuration in which three or more cutout portions are provided. For example, in an example shown in FIGS. 5 to 7, the second opening portion structure 24 includes four cutout portions 24a. The four cutout portions 24a are formed at equal intervals in a circumferential direction of the opening portion structure.

As described above, regarding an air passage type silencer including an expansion portion, it is known that turbulence of wind that flows into an expansion portion or that is discharged from the expansion portion is suppressed and a sound attenuation effect is enhanced in a case where a horn-shaped member (the opening portion structure), of which the cross-sectional area gradually decreases toward the inside of the expansion portion, is disposed at an entrance and exit port of the expansion portion.

Meanwhile, in a case where the air passage type silencer is used for a device like an air conditioner and a humidifier through which high-humidity air passes, the inside of the air passage type silencer is likely to be deteriorated due to moisture and humidity and mold is likely to be generated. Therefore, water accumulated in the expansion portion needs to be discharged to the outside. Therefore, it has been conceived to form a through-hole in a discharge gas lead-out pipe connected to the expansion portion.

However, according to the study of the present inventors, it has been found that air flowing through the opening portion structure is made turbulent by a through-hole and a wind noise is generated in a case where the through-hole is formed in the opening portion structure for suppression of turbulence of wind that flows into the expansion portion or that is discharged from the expansion portion.

On the other hand, in the case of the air passage type silencer according to the embodiment of the present invention which is shown in FIG. 1, the opening portion structure, of which the cross-sectional area gradually increases from a connection portion between the expansion portion 14 and a ventilation pipe toward the inside of the expansion portion 14, includes cutout portions that are formed from a distal end to a root side at a portion of a peripheral surface of the opening portion structure. Since the opening portion structure includes the cutout portions, water accumulated in the expansion portion can be discharged from the ventilation pipe. In the example shown in FIG. 1, the outlet-side ventilation pipe 16 is disposed below the expansion portion 14 in the vertical direction and the second opening portion structure 24 connected to the outlet-side ventilation pipe 16 includes the cutout portions 24a. Therefore, water W accumulated in the expansion portion 14 flows into through the cutout portions 24a of the second opening portion structure 24 and is discharged from the outlet-side ventilation pipe 16.

In addition, in the case of the air passage type silencer according to the embodiment of the present invention which is shown in FIG. 1, since the opening portion structure includes the cutout portions of which the width gradually increases from the root side to the distal end and that are open at the distal end, turbulence of air flowing through the opening portion structure can be suppressed and generation of a wind noise can be suppressed in comparison with a case where a through-hole of which an opening portion is closed is formed.

Furthermore, the air passage type silencer according to the embodiment of the present invention which is shown in FIG. 1 includes a porous sound absorbing material that is disposed between an inner peripheral surface of the expansion portion and the distal end of the opening portion structure and that includes a base material and a surface layer consisting of a nonwoven fabric and the surface layer side of the porous sound absorbing material is disposed on the opening portion structure side. That is, the surface layer side is disposed on a side on which wind flows. Therefore, since the surface layer that is smoother than the base material and at which turbulence is less likely to occur on a surface is on the side on which wind flows, turbulence can be reduced and a high-frequency wind noise can be reduced. In addition, since the surface layer at which water absorption is less likely to occur and that has a high density is disposed on the side on which high-humidity wind flows, the amount of water infiltrating into the expansion portion can be reduced and moisture absorption can be prevented.

As described above, in the case of the air passage type silencer according to the embodiment of the present invention, since no through-hole is formed in the main body of the air passage type silencer and the opening portion structure, a problem in which air flowing through the opening portion structure is made turbulent by a through-hole and a wind noise is generated does not occur.

Unless the air passage type silencer is used for a device like an air conditioner and a humidifier through which high-humidity air passes, a problem in which the inside of the air passage type silencer is deteriorated due to moisture and humidity and mold is generated does not occur.

Regardless of whether or not the air passage type silencer is used for a device like an air conditioner and a humidifier through which high-humidity air passes, a countermeasure of providing a moisture absorption sheet at an inlet-side opening portion and/or an outlet-side opening portion or installing a moisture absorption agent in the air passage type silencer can also be adopted.

Note that, in the example shown in FIG. 1, the air passage type silencer 10 is configured to include the first opening portion structure 20 and the second opening portion structure 24. However, the present invention is not limited thereto as long as the air passage type silencer 10 includes at least one of the opening portion structures. In addition, a configuration in which the first opening portion structure 20 and the second opening portion structure 24 are provided and only one of the opening portion structures includes cutout portions may also be adopted.

In a case where the air passage type silencer 10 is disposed such that the flow path direction is parallel to the vertical direction, it is preferable that an opening portion structure disposed at a surface of the expansion portion 14 that is on a lower side in the vertical direction includes cutout portions. That is, it is preferable that the second opening portion structure 24 connected to the outlet-side ventilation pipe 16 includes the cutout portions 24a in the case of a configuration in which the outlet-side ventilation pipe 16 is disposed on the lower side in the vertical direction as in the example shown in FIG. 1 and it is preferable that the first opening portion structure 20 connected to the inlet-side ventilation pipe 12 includes the cutout portions 20a in the case of a configuration in which the inlet-side ventilation pipe 12 is disposed on the lower side in the vertical direction.

In addition, in the example shown in FIG. 1, the porous sound absorbing material 30 is disposed over the entire expansion portion 14 in the flow path direction. However, the present invention is not limited thereto. The porous sound absorbing material 30 may be disposed at least at the positions of the distal ends of the opening portion structures in the flow path direction and for example, a configuration in which the porous sound absorbing material 30 is disposed between the distal end of the first opening portion structure 20 and the distal end of the second opening portion structure 24 may also be adopted.

In addition, a configuration in which the porous sound absorbing material is disposed over the every surface of the expansion portion in the circumferential direction may also be adopted but the porous sound absorbing material does not need to be disposed over the every surface of the expansion portion in the circumferential direction. For example, a configuration in which porous sound absorbing materials are disposed on two opposite surfaces of a rectangular expansion portion without being disposed on the other two surfaces may also be adopted. Accordingly, porous sound absorbing materials on two surfaces are not necessary and thus reduction in thickness of an air passage type silencer can be realized. In addition, a configuration in which the thicknesses of porous sound absorbing materials change depending on the place and, for example, the porous sound absorbing materials disposed on the two opposite surfaces are thin porous sound absorbing materials may also be adopted.

In addition, in the case of, for example, a configuration in which porous sound absorbing materials are disposed on two opposite surfaces of a rectangular expansion portion without being disposed on the other two surfaces, it is preferable that the cutout portions of the opening portion structures are disposed to face the porous sound absorbing materials. Accordingly, the area of contact between wind and the porous sound absorbing materials is increased and a sound absorbing effect is further improved.

In addition, the depth (the length in the axial direction) of a cutout portion is preferably 1.0 to 0.1, more preferably 0.9 to 0.2, and still more preferably 0.8 to 0.3 in a case where the height of an opening portion structure is 1.

In addition, the width of the cutout portion at a distal end is preferably 5 to 1, more preferably 3 to 1.2, and still more preferably 2 to 1.1 in a case where the root width of the opening portion structure is 1.

In addition, in examples shown in FIGS. 2 to 4 and FIGS. 5 to 7, the width of a cutout portion increases from the root toward the distal end at a certain rate in an approximately V-like shape. However the present invention is not limited thereto. For example, a rate at which the width increases from the root toward the distal end may change as in the case of an approximately U-like shape. Alternatively, a shape of which the width increases stepwise may also be adopted.

In addition, in a case where there is no cutout portion, the shape of each of the opening portion structures shown in FIGS. 2 to 4 and FIGS. 5 to 7 is a horn-like (trumpet-like) shape with an edge surface on a ventilation pipe side having a circular shape, the diameter of the opening portion structure increasing toward the inside of the expansion portion, and a rate at which the diameter increases increasing from the root toward the distal end, that is, a shape with the cross-sectional shape of the opening portion structure in a cross section parallel to the flow path direction (the central axis) being convex toward a central axis side. However, the present invention is not limited thereto. For example, the cross-sectional shape of the opening portion structure in the cross section parallel to the flow path direction may be a linear shape. Alternatively, the cross-sectional shape of the opening portion structure in the cross section parallel to the flow path direction may be partially concave toward the central axis side. Alternatively, for example, the cross-sectional shape of the opening portion structure in the cross section parallel to the flow path direction may be a shape of which the diameter increases stepwise with a portion of which the diameter monotonically increases along the central axis, a portion of which the diameter is constant, and a portion of which the diameter monotonically increases disposed in this order.

In addition, in a case where there is no cutout portion, the shape of each of the opening portion structures shown in FIGS. 2 to 4 and FIGS. 5 to 7 is a shape with a cross section perpendicular to the central axis being circular. However, the present invention is not limited thereto and the cross section of the opening portion structure that is perpendicular to the central axis may have an oval shape, a rectangular shape, or a polygonal shape. The cross section of the opening portion structure that is perpendicular to the central axis may have any shape as long as the area of the cross section perpendicular to the central axis gradually increases from the connection portion toward the inside of the expansion portion. It is preferable that the cross-sectional shape of the opening portion structure that is perpendicular to the central axis is similar to the cross-sectional shape of the expansion portion.

In addition, in the example shown in FIG. 1, the air passage type silencer is disposed such that the flow path direction is parallel to the vertical direction. However, the present invention is not limited thereto. The air passage type silencer may be disposed such that the flow path direction is oblique with respect to the vertical direction, or may be disposed such that the flow path direction is orthogonal to the vertical direction. In a case where the air passage type silencer is disposed to be oblique with respect to the vertical direction or to be orthogonal to the vertical direction, it is preferable that the cutout portions of the opening portion structure are formed at positions on a lower side in the vertical direction.

Examples of the materials of the ventilation pipe, the expansion portion, and the opening portion structure include a metal material, a resin material, a reinforced plastic material, and a carbon fiber. Examples of the metal material include metal materials such as aluminum, titanium, magnesium, tungsten, iron, steel, chromium, chromium molybdenum, nichrome molybdenum, and alloys thereof. Examples of the resin material include resin materials such as acrylic resin (PMMA), polymethyl methacrylate, polycarbonate, polyamide, polyalylate, polyetherimide, polyacetal, polyetheretherketone, polyphenylene sulfide, polysulfone, polyethylene terephthalate, polybutylene terephthalate (PET), polyimide, triacetylcellulose (TAC), polypropylene (PP), polyethylene (PE), polystyrene (PS), ABS resin (copolymer synthetic resin of acrylonitrile, butadiene, and styrene), flame-retardant ABS resin, ASA resin (copolymer synthetic resin of acrylonitrile, styrene, and acrylate), polyvinyl chloride (PVC) resin, and polylactic acid (PLA) resin. In addition, examples of the reinforced plastic material include carbon fiber reinforced plastics (CFRP) and glass fiber reinforced plastics (GFRP).

From the viewpoint of weight reduction, easy molding, and the like, it is preferable to use a resin material as the material of the air passage type silencer. In addition, as described above, from the viewpoint of low-frequency range sound insulation, it is preferable to use a material having a high stiffness. From the viewpoint of weight reduction and sound insulation, the density of a member constituting the air passage type silencer is preferably 0.5 g/cm³ to 2.5 g/cm³.

It is desirable that these materials are non-flammable, flame-retardant, and self-extinguishing. In addition, it is also desirable that the entire air passage type silencer is non-flammable, flame-retardant, and self-extinguishing.

Here, in an example shown in FIG. 1, the air passage type silencer includes, as a sound attenuation mechanism, the expansion portion and the sound absorbing material (the porous sound absorbing material). In the air passage type silencer shown in FIG. 1, a resonator may be formed by a space surrounded by an outer side surface of the opening portion structure (a surface opposite to the central axis) and a wall surface of the expansion portion and an opening portion of the space. That is, the air passage type silencer shown in FIG. 1 can include, as the sound attenuation mechanism, the resonator in addition to the expansion portion and the sound absorbing material.

The expansion portion is a mechanism that changes an impedance by rapidly changing (increasing or decreasing) the area of a flow path, so that a sound wave is reflected and a sound is attenuated.

The resonator is an air-column resonator, a Helmholtz resonator, or the like, and is a mechanism that attenuates a sound by using sound resonance.

The sound absorbing material is a mechanism that attenuates a sound by converting the sound energy of an incident sound wave into thermal energy.

Examples of the sound absorbing material include a plate-shaped material (a film-shaped material), a micro perforated plate, a molded sound absorbing plate, a flexible material, and the like in addition to the above-mentioned porous sound absorbing material.

The plate-shaped material (the film-shaped material) is a plate-shaped or film-shaped member such as plywood, a canvas (cloth woven with thick fibers), a film, and a sheet. Regarding the plate-shaped member (the film-shaped member), plate vibration (film vibration) is generated in a case where a sound wave collides with the plate-shaped member (the film-shaped material) and a sound is absorbed with sound energy converted into thermal energy due to friction.

The micro perforated plate is a plate-shaped member with a hole like a perforated board or perforated metal, and air in a hole portion vibrates in a case where a sound wave collides with the hole portion so that a sound is absorbed with sound energy converted into thermal energy due to friction.

The molded sound absorbing plate is formed by molding a fibrous member such as a resin fiber like rockwool, glass wool, and polyester to have a high density and to have plate-like shape through high-pressure compression processing. Since such a molded sound absorbing plate is a porous plate-shaped member, as with the porous sound absorbing material, air in a cavity vibrates in a case where a sound wave collides with the molded sound absorbing plate inside so that a sound is absorbed with sound energy converted into thermal energy due to friction.

The flexible material is a low-stiffness flexible material like a rubber sheet and the flexible material vibrates in a case where a sound wave collides with the flexible material so that a sound is absorbed with sound energy converted into thermal energy due to friction.

In addition, in the example shown in FIG. 1, the porous sound absorbing material 30 has a configuration with the base material 31 and the surface layer 32. However, the present invention is not limited thereto and a single-layer porous sound absorbing material may also be adopted. As the single-layer porous sound absorbing material, a porous sound absorbing material, a woven fabric, a nonwoven fabric, and the like mentioned as the base material and the surface layer described above can be appropriately used.

Note that the air passage type silencer according to the embodiment of the present invention may include, as the sound attenuation mechanism, at least one of the expansion portion, the sound absorbing material, or the resonator.

In addition, in the air passage type silencer shown in FIG. 1, the opening portion structure is a horn-shaped member of which the cross-sectional area gradually increases from a root portion toward a distal end portion. However, the present invention is not limited thereto.

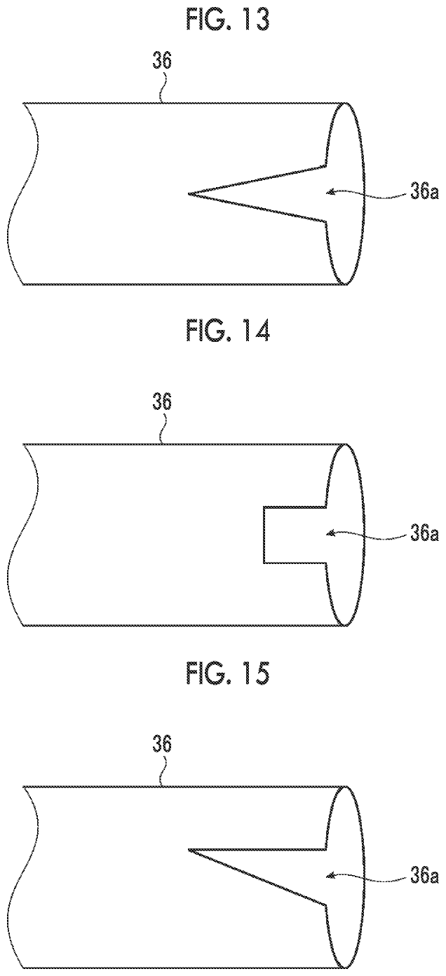

The opening portion structure may be a straight pipe-shaped member as shown in FIG. 13.

An opening portion structure 36 shown in FIG. 13 is a straight pipe-shaped member and includes a drainage mechanism 36a at an edge portion on a distal end side. Similar to the example shown in FIG. 1 and the like, the drainage mechanism 36a shown in FIG. 13 is a cutout portion of which the width gradually increases from the distal end side toward a root side.

In addition, the air passage type silencer shown in FIG. 1 has a configuration in which the opening portion structure includes, as a drainage mechanism, the cutout portions of which the width gradually increases from the root side toward the distal end side. However, the present invention is not limited thereto. The drainage mechanism may be formed at a portion of an edge portion of the opening portion structure.

Each of FIGS. 14 and 15 shows a perspective view schematically showing an opening portion structure including another example of the drainage mechanism.

The opening portion structure 36 shown in FIG. 14 is a straight pipe-shaped member and includes the drainage mechanism 36a at the edge portion on the distal end side. As shown in FIG. 14, the drainage mechanism 36a is a notch that extends from the distal end side to the root side and of which the width is constant. As described above, the drainage mechanism may be a notch of which the width is constant.

The opening portion structure 36 shown in FIG. 15 is a straight pipe-shaped member and includes the drainage mechanism 36a at the edge portion on the distal end side. The drainage mechanism 36a shown in FIG. 15 is a cutout portion of which the width gradually increases from the distal end side toward a root side.

The shape of the drainage mechanism 36a that the opening portion structure 36 shown in FIG. 13 includes is a shape of which the width increases from an end side toward the root side in an equidistant manner in a circumferential direction, that is, an isosceles triangle in a case where the cutout portion is seen in plan view (in a case where the cutout portion is seen in a direction perpendicular to the paper plane of FIG. 13). Meanwhile, the shape of the drainage mechanism 36a that the opening portion structure 36 shown in FIG. 15 includes is a shape of which the width increases from the end side toward the root side to one side in the circumferential direction, that is, a right-angled triangle in a case where the cutout portion is seen in plan view.

As described above, various shapes can be adopted as the shape of the drainage mechanism.

### EXAMPLES

Hereinafter, the present invention will be more specifically described based on examples. Materials, used amounts, ratios, treatment contents, treatment procedures, and the like described in the following examples can be appropriately changed without departing from the spirit of the present invention. Therefore, the scope of the present invention should not be construed as being limited to Examples shown below.

### Comparative Example 1

An expansion portion was formed of ABS resin by using a 3D printer (manufactured by XYZ printing, Inc.). The expansion portion had a rectangular parallelepiped shape having a size of 80 mm×80 mm and a length of 150 mm. The thickness of the ABS resin was 2 mm. In addition, holes having a diameter of 34 mm were formed on both side surfaces of the expansion portion, and hoses having an inner diameter of 30 mm and a thickness of 2 mm were connected as an inlet-side ventilation pipe and an outlet-side ventilation pipe.

Two horn-shaped cylinders (having an inner diameter of 30 mm on a narrow side, an inner diameter of 50 mm on a wide side, a length of 50 mm in the flow path direction, and a thickness of 2 mm and formed of ABS) of which both sides were open were manufactured by using a 3D printer. An increase in horn diameter was exponential. The horn-shaped cylinders were attached, as opening portion structures, to a connection portion with respect to the inlet-side ventilation pipe of the expansion portion and to a connection portion with respect to the outlet-side ventilation pipe of the expansion portion with openings on narrow sides (sides of a diameter of 30 mm) being aligned therewith. The opening portion structures are structures with no cutout portion.

In the expansion portion, a porous sound absorbing material having a thickness of 15 mm (QonPET manufactured by Bridgestone KBG Co., Ltd.) was disposed along an interior wall. In this manner, an air passage type silencer in which air was present in a region having a size of 50 mm×50 mm in the expansion portion and the porous sound absorbing material of 15 mm was present on the outer periphery thereof was manufactured. Note that the porous sound absorbing material includes a base material consisting of polyester resin and a nonwoven fabric surface layer and is disposed such that the base material faces an interior wall side of the expansion portion.

### Comparative Example 2

An air passage type silencer was manufactured in the same manner as in Comparative Example 1 except that the porous sound absorbing material was changed to a sound-absorbing board (manufactured by IMAO CORPORATION). This porous sound absorbing material has a base material consisting of a urethane resin and a nonwoven fabric surface layer.

### Comparative Example 3

An air passage type silencer was manufactured in the same manner as in Comparative Example 1 except that a plurality of porous sound absorbing materials are disposed by being stacked in the flow path direction such that nonwoven fabric surface layers thereof are orthogonal to the flow path direction as shown in FIG. 10.

### Comparative Example 4

An air passage type silencer was manufactured in the same manner as in Comparative Example 3 except that the porous sound absorbing material was changed to (a sound-absorbing board manufactured by IMAO CORPORATION).

### Comparative Example 7

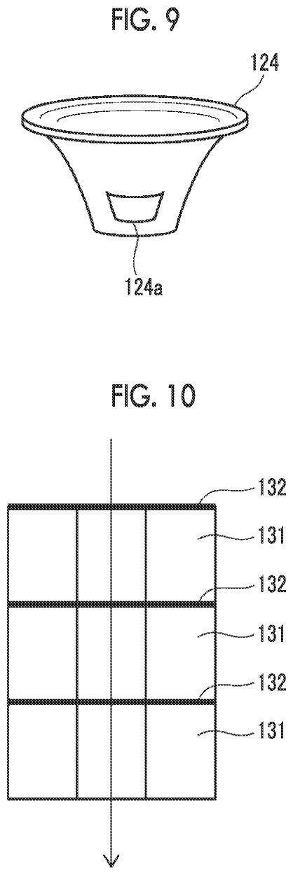

An air passage type silencer was manufactured in the same manner as in Comparative Example 1 except that one through-hole having a size of 10 mm×10 mm was formed on a root side of an opening portion structure as shown in FIG. 9.

### Comparative Example 8

An air passage type silencer was manufactured in the same manner as in Comparative Example 7 except that the porous sound absorbing material was changed to (a sound-absorbing board manufactured by IMAO CORPORATION).

### Comparative Example 9

An air passage type silencer was manufactured in the same manner as in Comparative Example 7 except that a plurality of porous sound absorbing materials are disposed by being stacked in the flow path direction such that nonwoven fabric surface layers thereof are orthogonal to the flow path direction as shown in FIG. 10.

### Comparative Example 10

An air passage type silencer was manufactured in the same manner as in Comparative Example 9 except that the porous sound absorbing material was changed to (a sound-absorbing board manufactured by IMAO CORPORATION).

### Example 1

An air passage type silencer was manufactured in the same manner as in Comparative Example 1 except that four V-shaped cutout portions having a depth of 40 mm and a width of 50 mm at a distal end are formed at equal intervals in a circumferential direction at an opening portion structure.

### Example 2

An air passage type silencer was manufactured in the same manner as in Example 1 except that the porous sound absorbing material was changed to (a sound-absorbing board manufactured by IMAO CORPORATION).

### [Evaluation]

### <Drainability>

100 ml of water was poured into each of the expansion portions of the manufactured air passage type silencers, the weights of the air passage type silencers were measured in advance, wind of which the temperature was 25° C., the humidity was 50% RH, and the flow rate was 1 m/s was caused to flow from the inlet-side ventilation pipes, and the numbers of days taken for the amount of remaining moisture to reach 1 mL were evaluated based on the following criteria.
A: 7 days or less
B: More than 7 days and 10 days or less
C: More than 10 days

### <Air Passage Properties>

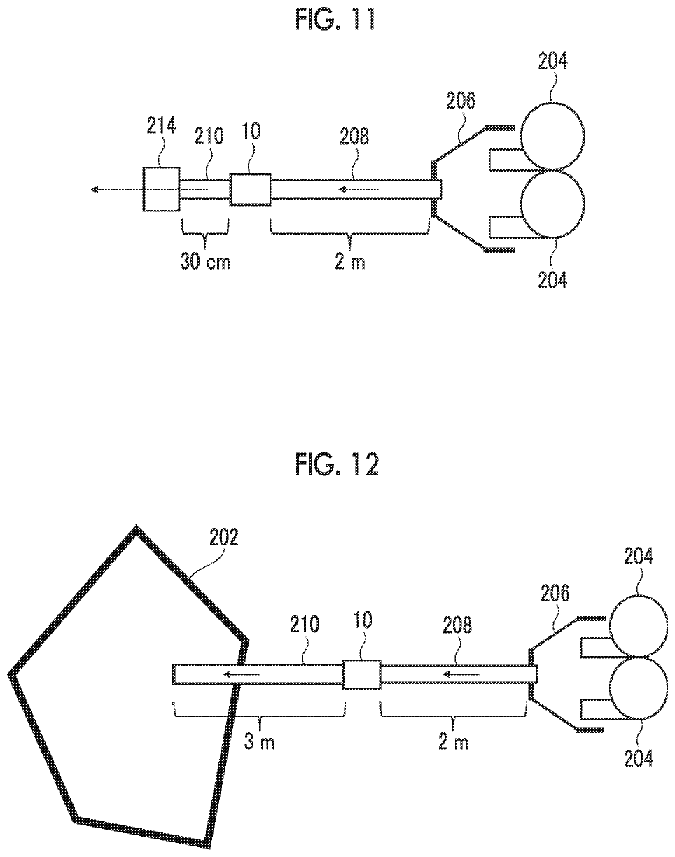

As shown in FIG. 11, an inlet-side hose 208 was connected to the inlet-side ventilation pipe of the air passage type silencer and two blower fans (San Ace DC blowers manufactured by SANYO DENKI CO., LTD. (model number: 9BMC24P2G001)) 204 were disposed on a distal end side of the inlet-side hose 208. A rectifying plate 206 that was formed such that air sent from the blower fans 204 driven at a rotation speed of 7000 rpm flows into the inlet-side hose 208 was connected. An outlet-side hose 212 having a length of 30 cm was connected to the outlet-side ventilation pipe of the air passage type silencer, and a wind speed meter (a wind speed and wind flow volume meter TM-413 manufactured by TENMARS ELECTRONICS CO., LTD.) 214 was connected to a distal end of the outlet-side hose 212.

The two blower fans 204 were driven to send air, and a wind speed passing through the air passage type silencer was measured by using the wind speed meter 214. With the wind speed measured by the wind speed meter, an air passage rate was obtained based on the following expression and evaluation was performed based on the following criteria.

(air passage rate)=(wind speed of wind speed meter)×(air reception area of wind speed meter)
A: 0.7 m³/min or more
B: less than 0.7 m³/min

### <Sound Attenuation Amount>

As shown in FIG. 12, the inlet-side hose 208 having a length of 2 m was connected to the inlet-side ventilation pipe of the air passage type silencer and two blower fans (San Ace DC blowers manufactured by SANYO DENKI CO., LTD. (model number: 9BMC24P2G001)) 204 were disposed on a distal end side of the inlet-side hose 208. A rectifying plate 206 that was formed such that air sent from the blower fans 204 driven at a rotation speed of 7000 rpm flows into the inlet-side hose 208 was connected. In addition, an outlet-side hose 210 having a length of 3 m was connected to the outlet-side ventilation pipe, and a distal end of the outlet-side hose 210 was disposed in a reverberation chamber 202. Four measurement microphones were installed in the reverberation chamber 202.

The two blower fans 204 were driven to send air, measurement was carried out with the four measurement microphones to measure a sound pressure level in a frequency range of 1000 Hz to 4000 Hz corresponding to a wind noise.

By using a state where the air passage type silencer is not disposed and the inlet-side hose 208 and the outlet-side hose 210 are directly connected to each other as a reference, differences between sound pressure levels in Examples and Comparative Examples and a sound pressure level in the reference were obtained as sound attenuation amounts and evaluation on the maximum values of the sound attenuation amounts was performed based on the following criteria.
A: 5 dB or more
B: 4 dB or more and less than 5 dB
C: less than 4 dB

The results are shown in Table 1. Note that in Table 1, regarding the disposition of the porous sound absorbing material, “vertical disposition” corresponds to a case where the surface layer is disposed to face an opening portion structure side and “lateral disposition” corresponds to a case where the surface layer is disposed to be perpendicular to the flow path direction.

TABLE 1

| | | Porous Sound Absorbing Material | | Evaluation | | |
|---|---|---|---|---|---|---|
| | Cutout | | Type of Base | | Air Passage | Sound Attenuation |
| | Portion | Disposition | Material | Drainability | Properties | Amount |
| Example 1 | Provided | Vertical | Polyester resin | A | A | A |
| | | disposition | | | | |
| Example 2 | Provided | Vertical | Urethane resin | B | A | A |
| | | disposition | | | | |
| Comparative | Not | Vertical | Polyester resin | C | A | A |
| Example 1 | provided | disposition | | | | |
| Comparative | Not | Vertical | Urethane resin | C | A | A |
| Example 2 | provided | disposition | | | | |
| Comparative | Not | Lateral | Polyester resin | C | B | B |
| Example 3 | provided | disposition | | | | |
| Comparative | Not | Lateral | Urethane resin | C | B | B |
| Example 4 | provided | disposition | | | | |
| Comparative | Hole | Vertical | Polyester resin | A | A | C |
| Example 7 | | disposition | | | | |
| Comparative | Hole | Vertical | Urethane resin | B | A | C |
| Example 8 | | disposition | | | | |
| Comparative | Hole | Lateral | Polyester resin | B | B | C |
| Example 9 | | disposition | | | | |
| Comparative | Hole | Lateral | Urethane resin | B | B | C |
| Example 10 | | disposition | | | | |

It can be found from Table 1 that in Examples of the present invention, both the drainability and the sound attenuation amount (suppression of a wind noise) can be achieved in comparison with the Comparative Examples. In addition, the air passage properties can also be improved.

It can be found that in Comparative Examples 1 to 4, the drainability is poor since the opening portion structure includes no cutout portion. In addition, it can be found that in Comparative Examples 3 and 4, wind comes into contact with the base material and the flow thereof is made turbulent since the porous sound absorbing material is disposed laterally, so that the air passage properties and the sound attenuation amount are made poor.

It can be found that in Comparative Examples 7 to 10, there is improvement in drainability since the opening portion structure includes a hole but the sound attenuation amount is poor since a wind noise is generated due to turbulence of the flow of wind which is caused by the hole.

It can be found from the result of comparison between Example 1 and Example 2 that the drainability is improved more in a case where the water absorption rate of resin serving as the base material of the porous sound absorbing material is low.

As understood from the above results, the effect of the present invention is obvious.

### EXPLANATION OF REFERENCES

10: air passage type silencer
12: inlet-side ventilation pipe
14: expansion portion
16: outlet-side ventilation pipe
20: first opening portion structure
22: first rear surface space
24: second opening portion structure
26: second rear surface space
30: porous sound absorbing material
31: base material
32: surface layer
36: opening portion structure
36a: cutout portion (drainage mechanism)

What is claimed is:

1. An air passage type silencer comprising:
an inlet-side ventilation pipe;
an expansion portion that communicates with the inlet-side ventilation pipe and of which a cross-sectional area is larger than the cross-sectional area of the inlet-side ventilation pipe;
an outlet-side ventilation pipe that communicates with the expansion portion and of which a cross-sectional area is smaller than a cross-sectional area of the expansion portion;
an opening portion structure that is provided at at least one of a connection portion between the expansion portion and the inlet-side ventilation pipe or a connection portion between the expansion portion and the outlet-side ventilation pipe and of which a cross-sectional area gradually increases from the connection portion toward an inside of the expansion portion; and
a sound absorbing material that is disposed at least between an inner peripheral surface of the expansion portion and a distal end of the opening portion structure,
wherein the opening portion structure includes a cutout portion formed from the distal end to a root side at a portion of a peripheral surface,
a width of the cutout portion gradually increases from the root side toward the distal end,
a central axis of the inlet-side ventilation pipe and a central axis of the outlet-side ventilation pipe are disposed to be parallel to a vertical direction, and
the opening portion structure including the cutout portion is disposed at a side surface of the expansion portion that is on a lower side in the vertical direction.

2. The air passage type silencer according to claim 1,
wherein the opening portion structure is provided at each of the connection portion between the expansion portion and the inlet-side ventilation pipe and the connection portion between the expansion portion and the outlet-side ventilation pipe.

3. The air passage type silencer according to claim 1,
wherein the sound absorbing material is a porous sound absorbing material.

4. The air passage type silencer according to claim 3,
wherein the porous sound absorbing material includes a base material that consists of resin and a surface layer that is on a surface of the base material and that consists of a resin nonwoven fabric, and
the porous sound absorbing material is disposed such that a surface layer side faces an opening portion structure side.

5. The air passage type silencer according to claim 4,
wherein a water absorption rate of resin for the base material of the porous sound absorbing material is 0.5% or less.

6. The air passage type silencer according to claim 3,
wherein a central axis of the inlet-side ventilation pipe and a central axis of the outlet-side ventilation pipe coincide with each other, and
the porous sound absorbing material is disposed along the inner peripheral surface of the expansion portion over an entire region in a direction along the central axes.

7. The air passage type silencer according to claim 3,
wherein the porous sound absorbing material is in contact with a maximum diameter portion of the opening portion structure.

8. The air passage type silencer according to claim 1,
wherein the opening portion structure does not include a through-hole.

9. The air passage type silencer according to claim 2,
wherein the sound absorbing material is a porous sound absorbing material.

10. The air passage type silencer according to claim 9,
wherein the porous sound absorbing material includes a base material that consists of resin and a surface layer that is on a surface of the base material and that consists of a resin nonwoven fabric, and
the porous sound absorbing material is disposed such that a surface layer side faces an opening portion structure side.

11. The air passage type silencer according to claim 10,
wherein a water absorption rate of resin for the base material of the porous sound absorbing material is 0.5% or less.

12. The air passage type silencer according to claim 9,
wherein a central axis of the inlet-side ventilation pipe and a central axis of the outlet-side ventilation pipe coincide with each other, and
the porous sound absorbing material is disposed along the inner peripheral surface of the expansion portion over an entire region in a direction along the central axes.

13. The air passage type silencer according to claim 9,
wherein the porous sound absorbing material is in contact with a maximum diameter portion of the opening portion structure.

14. The air passage type silencer according to claim 2,
wherein the opening portion structure does not include a through-hole.

15. The air passage type silencer according to claim 3,
wherein the opening portion structure does not include a through-hole.

16. The air passage type silencer according to claim 4,
wherein the opening portion structure does not include a through-hole.

17. The air passage type silencer according to claim 5,
wherein the opening portion structure does not include a through-hole.

18. The air passage type silencer according to claim 6,
wherein the opening portion structure does not include a through-hole.
